(19) United States
(12) Patent Application Publication
(10) Pub. No.: US 2024/0351883 A1
(43) Pub. Date: Oct. 24, 2024

(54) POLYALKYLENE OXIDES AS DISPERSANT FOR GRAPHENE MATERIAL

(71) Applicant: Evonik Operations GmbH, Essen (DE)

(72) Inventors: Kathrin LEHMANN, Leverkusen (DE); Stefan Schumann, Remscheid (DE); Valeri Leich, Duisburg (DE); Verena Breuers, Haltern am See (DE); Jonas Hönig, Ingelheim am Rhein (DE); Lea Muchajer, Leverkusen (DE); Thorsten Hoven, Essen (DE); Peter Seidensticker, Haan (DE)

(73) Assignee: Evonik Operations GmbH, Essen (DE)

(21) Appl. No.: 18/575,875

(22) PCT Filed: Jun. 29, 2022
(86) PCT No.: PCT/EP2022/067880

§ 371 Date: Jan. 1, 2024

(30) Foreign Application Priority Data
Jul. 2, 2021 (EP) 21183328.0

(51) Int. Cl. C01B 32/194

(52) U.S. Cl. CPC C01B 32/194; C01P 2006/22

(57) ABSTRACT

A polyalkylene oxide having at least one aromatic radical is a dispersant for a graphene material. A process for dispersing graphene material is developed where the abovementioned polyalkylene oxides are employed as the dispersant. Compositions including the abovementioned dispersant and graphene material are produced.

The present invention relates to polyalkylene oxides as dispersant for graphene material.

Graphene material is used in a large number of technical fields. Graphene and the production, properties and uses thereof are discussed in detail in the technical literature (see Rompp online, https://roempp.thieme.de/lexicon/RD-07-02758; Angew Chem. Int. Ed. 2014, 53, 7714-7718; Mater. Today 2012, 15 (3) 86-97).

Graphene material is available commercially in powder form and often has very low bulk densities, for example in the range between 2 and 400 g/l. Alongside low bulk densities, graphene material also has poor flowability and/or generates a high dust content when transferred by gravity-driven flow. This results in poor handling properties, problems during weighing and metering, and must also be considered critical in terms of environmental protection and occupational safety. Closed systems for loading solids are likewise of only limited effectiveness, because although the occupational safety issues can be thus addressed, the problem of “bridging” during continuous or semi-continuous dosing of graphene material in dispersing vessels, kneaders or extrusion lines is not solved. Bridging is understood to mean inhomogeneous dosing of solids that can result in the feeder becoming blocked and thus needing to be opened and mechanically freed, which is undesirable. Volumetric dosing is consequently often not practicable at all and gravimetric dosing is impaired.

The poor handling is manifest also for example when incorporating pulverulent graphene material into solvents and monomer resins for thermal interface materials and sealants and adhesives. The incorporation of graphene material into liquid systems is generally a challenge. The production of, for example, well-filled sealants and adhesives is usually dependent on incorporating pulverulent fillers at the right time and over the right period of time. The shear forces acting on the mixing process break up filler agglomerates and thus contribute to dispersal. The maximum filler level that can be achieved is therefore substantially determined by the shear forces acting on it. Solvents and resins are on their own able to attach to and stabilize freshly generated surfaces and functional groups only inadequately, which results in separation and sedimentation. This can prevent a usable stable dispersion from being achieved for further processing in formulations. Moreover, accurate and reliable dosing is important for sealants and adhesives with readily controllable viscosity, in order that good interfacial contacts and thus strong adhesion or else thermal and electrical conductivity in use can be achieved. The quality of the adhesive or sealant and also the strength of the effect to be achieved, for example increased thermal or electrical conductivity, are strongly dependent on the dispersibility of the fillers and on their influence on the properties of the overall formulation (e.g. viscosity). The above considerations apply to other liquid systems too.

The production of stable dispersions of graphene material is however problematic. Graphene material has a tendency to agglomeration. These aggregates in turn lead to sedimentation, which is undesirable.

To improve the dispersibility of graphene material in solid and liquid systems, the use of dispersants is proposed in the prior art.

WO 2012/059489 A1 discloses for example polymer compositions, in particular for thermoplastics or thermosets comprising carbon substrates capable of electrical conduction, such as carbon black, carbon fibres, graphite, graphene and/or CNTs (carbon nanotubes) as well as salts having a non-metal cation or a synergistic mixture of such salts together with metal salts, wherein combination with special dispersants is essential. These special dispersants are dispersants based on esters or amides. It is preferable here that the dispersants are selected from
c1) polyacrylic esters producible by transesterification of an alkyl polyacrylate obtainable by polymerization, the alkyl radicals of which contain 1 to 3 carbon atoms, with
   a) saturated aliphatic alcohols having 4 to 50 carbon atoms and/or
   b) unsaturated aliphatic alcohols having 4 to 50 carbon atoms, wherein a) and b) are used in amounts such that 30 to 100% of the ester groups undergo transesterification, and/or
c2) polyester-polyamine condensation products obtainable by the partial or complete reaction of
   A) one or more amino-functional polymers containing at least four amino groups with
   B) one or more polyesters of general formula (I)/(Ia)

T-C(O)—[O-A-C(O)]ₓ—OH (I)

T-O—[C(O)-A-O—]_{y}—Z (Ia)
and
C) one or more polyethers of general formula (II)/(IIa)

T-C(O)—B—Z (II)

T-O—B—Z (IIa)
in which
T is a hydrogen radical and/or an optionally substituted, linear or branched aryl, arylalkyl, alkyl or alkenyl radical having 1 to 24 carbon atoms,
A is an at least divalent radical selected from the group of linear, branched, cyclic and aromatic hydrocarbons,
Z is at least one radical, selected from the group of sulfonic acids, sulfuric acids, phosphonic acids, phosphoric acids, carboxylic acids, isocyanates, epoxides, especially phosphoric acid and (meth)acrylic acid,
B is a radical of general formula (III)

—(CₗH₂ₗO)ₐ—(CₘH₂ₘO)_{b}—(CₙH₂ₙO)_{c}—(SO)_{d}— (III)
SO=—CH₂—CH(Ph)-O—, where Ph=phenyl radical,
a,b,c are independently values from 0 to 100,
   with the proviso that the sum of a+b+c is ≥0, preferably 5 to 35, especially 10 to 20, with the proviso that the sum of a+b+c+d is >0,
d is ≥0, preferably 1 to 5,
l,m,n are independently ≥2, preferably 2 to 4,
x,y are independently ≥2.

Examples described for dispersant c1) are the commercially available products Tegomer® DA 100 N (Evonik), Tegomer® DA 102 (Evonik) and Tegomer® P121 (Evonik). An example mentioned for dispersant c2) is in turn the commercially available product Tegomer® DA 626 (Evonik). Numerous different dispersants have thus been disclosed, which in turn are suitable for dispersing numerous different carbon substrates. There is no disclosure of the combination of graphene material and polyalkylene oxides that contain at least one aromatic radical.

Other commercially available polyester-polyamine condensation products are also known from the prior art, for example Solsperse® 39000 (Lubrizol). Solsperse® 39000 has no aromatic radicals.

EP 1078946 A1 describes styrene oxide-containing polyalkylene oxide block copolymers obtained by alkoxylation and the use thereof as a low-foam pigment wetting agent in aqueous, optionally cosolvent-containing pigment pastes, aqueous and low-solvent paints and printing inks Numerous inorganic and organic pigments are mentioned as pigments. Particular preference should be given to dispersing additives for producing aqueous (gas) carbon black pastes. Specifically, black pastes are described that, in addition to said polyalkylene oxides, also comprise carbon black (Raven® 1170). There is however no disclosure of graphene material.

There therefore remained a need for dispersants for graphene material that have at least one advantage over the prior art. More particularly, these dispersants should allow high filler levels of graphene material and also permit stable dispersions having low viscosities. In addition, the dispersants should permit dispersion of graphene material in both polar and nonpolar, continuous, preferably liquid phases, wherein the continuous, preferably liquid phases should more particularly be solvent, monomer, oligomer or polymer compositions. It has surprisingly now been found that this object is achieved by the use of polyalkylene oxides having at least one aromatic radical as dispersant for graphene material.

The present invention therefore firstly provides for the use of polyalkylene oxides having at least one aromatic radical as dispersant for graphene material.

The present invention further provides a process for dispersing graphene material, characterized in that the polyalkylene oxides used according to the invention are employed as dispersants.

The present invention still further provides a composition comprising or consisting of:
(a) a continuous phase,
(b) a dispersant, corresponding to the use according to the invention, and
(c) graphene material.

The present invention still further provides a composition comprising or consisting of:
(i) a dispersant, corresponding to the use according to the invention, and
(j) graphene material.

Advantageous configurations of the subject-matter of the invention can be inferred from the claims, the examples and the description. Furthermore, it is explicitly pointed out that the disclosure relating to the subject-matter of the present invention includes all combinations of individual features of the description of the invention and of the claims. More particularly, embodiments of one subject of the invention are also applicable mutatis mutandis to the embodiments of the other subjects of the invention.

The inventors have established that the use of polyalkylene oxides having at least one aromatic radical as dispersant for graphene material has a number of advantages.

One advantage of the invention is the improved dispersibility of graphene material in both polar and nonpolar, continuous, preferably liquid phases, selected in particular from the group consisting of solvent, monomer, oligomer or polymer compositions. In contrast, the dispersants for graphene material known from the prior art are compatible only with very few continuous phases and tend to undergo demixing or to disperse inefficiently even at very high dispersant concentrations.

Another advantage of the invention is that it is possible to obtain dispersions having high filler levels of graphene material. The high filler levels allow electric and thermal conductivity to be achieved or improved in the dispersions.

A further advantage of the invention is improved handling and dosing in formulations, especially by comparison with graphene powders.

An advantage of the invention is likewise improved safety in handling, especially by comparison with pulverulent graphene material.

Another advantage of the invention is that the viscosity of compositions comprising graphene material can be selectively adjusted. This is because the viscosity usually increases sharply when dispersing graphene material and can cause the compositions to solidify, as a result of which the compositions may become unusable. At very low viscosities, on the other hand, it is not possible to generate the shear effect in a targeted manner during dispersion. This makes the dispersion process inefficient and does not result in adequate dispersion of the graphene material. By contrast, the polyalkylene oxides used according to the invention act as viscosity modifiers and allow the viscosity to be selectively adjusted so as to permit effective dispersion at low and at high viscosity and to obtain a stable, highly loaded dispersion of the graphene material.

A further advantage of the invention is that the polyalkylene oxides used according to the invention do not adversely affect the intrinsic properties of the graphene material. The incorporation of the dispersion into thermoplastic, thermoset or elastomer polymer systems for adhesives and sealants is made significantly easier or even made possible in the first place.

The subject-matter of the invention and preferred embodiments thereof are hereinbelow described by way of example without any intention that the invention be confined to these illustrative embodiments. Where ranges, general formulas or compound classes are specified hereinbelow, these are intended to include not only the corresponding ranges or groups of compounds that are explicitly mentioned but also all subranges and subgroups of compounds that can be obtained by taking out individual values (ranges) or compounds. Any embodiment that can be obtained by combination of ranges/subranges and/or groups/subgroups falls entirely within the disclosure content of the present invention and is considered to be explicitly, directly and unambiguously disclosed.

Where average values are stated hereinbelow, these values are numerical averages unless otherwise stated. Where measured values or material properties are stated hereinbelow, these are unless otherwise stated measured values or material properties measured at 25° C. and preferably at a pressure of 101 325 Pa (standard pressure). Room temperature (RT) is understood as meaning a temperature of 25° C.

Where numerical ranges in the form “from X to Y” or “X to Y” are stated hereinbelow, where X and Y represent the limits of the numerical range, this is synonymous with the statement “from at least X up to and including Y”, unless otherwise stated. Stated ranges thus include the range limits X and Y, unless otherwise stated.

Wherever molecules/molecule fragments have one or more stereocenters or can be differentiated into isomers on account of symmetries or can be differentiated into isomers on account of other effects, for example restricted rotation, all possible isomers are included by the present invention.

The word fragment “poly” encompasses compounds constructed from at least two monomer units.

The word fragment “Cₓ-C_{y}” in relation to a compound or a radical denotes a compound or a radical having from x to y carbon atoms. The designation “C₁-C₂₀ organyl radical” thus denotes an organyl radical, i.e. an organic radical, having 1 to 20 carbon atoms. The designation “C₁-C₈ acyl radical” accordingly denotes an acyl radical having 1 to 8 carbon atoms. The designation “C₁-C₈ alkyl radical” accordingly denotes an alkyl radical having 1 to 8 carbon atoms. The designation “C₅-C₁₃ hydrocarbon radical” refers accordingly to a hydrocarbon radical having 6 to 13 carbon atoms.

The formulas below describe compounds or structural units that may in turn be constructed from repeat units, for example repeat fragments, blocks or monomer units, and may have a molar mass distribution. The frequency of these repeat units is indicated by indices. The corresponding indices are the numerical average (number average) over all repeat units, unless otherwise stated. The indices used in the formulas for these units should therefore be regarded as statistical averages (numerical averages), unless otherwise stated. The indices used and also the value ranges of the stated indices are thus understood to be averages of the possible statistical distribution of the structures that are actually present and/or mixtures thereof, unless otherwise stated. The repeat units in the formulas hereinbelow may have any desired distribution. The structures constructed from the repeat units may have a blockwise construction with any number of blocks and any sequence or they may be subject to a randomized distribution; they may also have an alternating construction or else form a gradient along the chain, where one is present; in particular they can also form any mixed forms in which it is possible for groups having different distributions to follow one another. Specific embodiments may result in statistical distributions being restricted as a consequence of the embodiment. For all regions unaffected by the restriction, the statistical distribution is unchanged.

The invention firstly provides for the use of polyalkylene oxides having at least one aromatic radical as dispersant for graphene material.

The plural “polyalkylene oxides” here denotes one or more than one polyalkylene oxide, preferably more than one polyalkylene oxide.

The singular “graphene material” denotes one or more graphene materials, preferably one graphene material.

“Use of polyalkylene oxides having at least one aromatic radical as dispersant for graphene material” is thus synonymous with “use of one or more polyalkylene oxides having at least one aromatic radical as dispersant for one or more graphene materials”.

“Use of polyalkylene oxides having at least one aromatic radical as dispersant for graphene material” is thus also synonymous with “use of at least one polyalkylene oxide having at least one aromatic radical as dispersant for at least one graphene material”.

The polyalkylene oxides are hereinbelow therefore also referred to as dispersants. The dispersant thus consists of the polyalkylene oxides employable according to the invention.

In order to achieve the object of the invention, the polyalkylene oxides employable according to the invention must have at least one aromatic radical. Without being bound to any particular theory, it is assumed that the aromatic radical improves the interaction of the polyalkylene oxides with the graphene material.

It is preferable that the at least one aromatic radical is a phenyl radical.

In order to achieve an optimum effect, it is further preferable that the proportion by mass of all aromatic radicals based on the total mass of the dispersant is from 2% to 40%, preferably from 5% to 25%, especially from 7% to 15%

The polyalkylene oxides contain units of the formula (A)

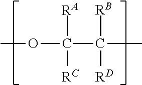

where the radicals R^{A}, R^{B}, R^{C} and R^{D} are each independently organic radicals or hydrogen (H). The organic radicals may each independently be linear or branched or cyclic, saturated or unsaturated, aliphatic or aromatic, substituted or unsubstituted, or else a combination thereof, where this is possible (e.g. cycloaliphatic). The proviso applies here that at least one unit is present in which at least one of the radicals R^{A}, R^{B}, R^{C} and R^{D} is an aromatic radical. The organic radicals are preferably hydrocarbon radicals that do not contain heteroatoms, especially C₁-C₈ hydrocarbon radicals that do not contain heteroatoms. It is preferable that the polyalkylene oxides comprise those units in which exactly one of the four radicals R^{A}, R^{B}, R^{C} and R^{D} is a phenyl radical and the other three radicals are hydrogen (H). It is thus preferable that the polyalkylene oxides have at least one unit of formula —O—CH₂—CHPh- or of formula —CH₂—CHPh-O—, where Ph denotes a phenyl radical.

It is further preferable that the polyalkylene oxides are selected from compounds of general formula (B),

R¹[O(SO)ₐ(PO)_{b}(BO)_{c}(EO)_{d}R²]ₙ (B)
in which:
R¹ is in each case independently selected from the group of n-valent C₁-C₂₀ organyl radicals;
R² is in each case independently selected from the group consisting of C₁-C₈ acyl radicals, C₁-C₈ alkyl radicals and hydrogen,
SO=styrene oxide,
PO=propylene oxide,
BO=butylene oxide.
EO=ethylene oxide,
n=1 to 6, preferably 1 to 4, especially 1 to 3,
a=1 to 10, preferably 1 to 5, especially 1 to 3,
b=0 to 50, preferably 0 to 20, especially 0 to 15,
c=0 to 10, preferably 0 to 5, especially 0 to 3,
d=0 to 50, preferably 0 to 20, especially 0 to 15.

It is in formula (B) preferable that a+b+c+d≥3.

It is for example preferable that the polyalkylene oxides are selected from compounds of general formula (C),

R¹O(SO)ₐ(PO)_{b}(BO)_{c}(EO)_{d}R² (C)
in which:
R¹ is in each case independently selected from the group of monovalent C₆-C₁₃ hydrocarbon radicals,
R² is in each case independently selected from the group consisting of C₁-C₈ acyl radicals, C₁-C₈ alkyl radicals and hydrogen,
SO=styrene oxide,
PO=propylene oxide,
BO=butylene oxide,
EO=ethylene oxide,
a=1 to 1.9,
b=0 to 3,
c=0 to 3,
d=3 to 50,
with the proviso that d≥a+b+c.

It is in formula (C) preferable that a+b+c+d≥3.

It is further preferable that the polyalkylene oxides are selected from compounds of general formula (D),

R¹[O(SO)ₐ(PO)_{b}(BO)_{c}(EO)_{d}R²]ₙ (D)
in which
R¹ is in each case independently selected from the group of n-valent C₁-C₂₀ organyl radicals;
R² is in each case independently selected from the group consisting of C₁-C₈ acyl radicals, C₁-C₈ alkyl radicals and hydrogen,
SO=styrene oxide,
PO=propylene oxide.
BO=butylene oxide.
EO=ethylene oxide,
n=1 to 6, preferably 1 to 4, especially 1 to 3,
a=1 to 10, preferably 1 to 5, especially 1 to 3,
b=0 to 50, preferably 3 to 20, especially 3 to 15,
c=0,
d=0.

It is in formulas (B) and (C) and (D) preferable that a+b+c+d≥3, preferably ≥4, especially ≥5.

In formulas (B) and (C) and (D), SO (styrene oxide) denotes a unit of formula (A) in which exactly one of the four radicals R^{A}, R^{B}, R^{C} and R^{D} is a phenyl radical and the other three radicals are hydrogen (H).

In formulas (B) and (C) and (D), EO (ethylene oxide) denotes a unit of formula (A) in which all four radicals R^{A}, R^{B}, R^{C} and R^{D} are hydrogen (H).

In formulas (B) and (C) and (D), PO (propylene oxide) denotes a unit of formula (A) in which exactly one of the four radicals R^{A}, R^{B}, R^{C} and R^{D} is a methyl radical and the other three radicals are hydrogen (H).

In formulas (B) and (C) and (D), BO (butylene oxide) denotes a unit of formula (A) in which exactly one of the four radicals R^{A}, R^{B}, R^{C} and R^{D} is an ethyl radical and the other three radicals are hydrogen (H) or else in which exactly two of the four radicals R^{A}. R^{B}. R^{C} and R^{D} are methyl radicals and the other two radicals are hydrogen (H).

It will be common knowledge to those skilled in the art that compounds of formulas (B) and (C) and (D) are typically present in the form of a mixture. The different alkylene oxide monomers and proportion thereof in the overall polymer make it possible to control the hydrophobicity/hydrophilicity balance and in such a way that dispersants can be selectively tailored to the graphene material and to the continuous phase. EO units are hydrophilic in effect here and PO, BO and SO units hydrophobic.

The arrangement of the alkylene oxide units may occur for example randomly or in blocks. Particularly preferably, the alkylene oxide units are arranged in blocks. The polyalkylene oxides are thus preferably block copolymers. The polyalkylene oxides are thus preferably block copolymer polyalkylene oxides. It is thus preferable that the polyalkylene oxides are styrene oxide-based polyalkylene oxide block copolymers. It is preferable here that the hydrophobic units such as SO, PO or BO and the hydrophilic EO units form separate blocks. It is preferable that the hydrophilic EO units form a block that is present attached to R². R² is here preferably hydrogen (H). The hydrophobic units SO, PO and BO are preferably present between the EO block and R¹. It is thus preferable that the radical R¹, the SO, PO and BO units, and also the oxygen atom(s) that connect(s) R¹ to the alkylene oxide units form a contiguous portion in the polyalkylene oxide to which are in turn attached the EO units terminated by R². Thus, it may in one case be preferable that in formulas (B) and (C) and (D) d≥a+b+c and in another case that in formulas (B) and (C) and (D) d<a+b+c. In the first case the polyalkylene oxides are more hydrophobic and in the second case they are more hydrophilic.

R¹ may in addition to carbon and hydrogen atoms also contain heteroatoms, selected for example from N and O, in particular N. It is however preferable that R¹ contains no SO units, no PO units, no BO units and no EO units. Preferably, R¹ contains no heteroatoms. R¹ is preferably in each case independently selected from the group of monovalent C₈-C₁₃ hydrocarbon radicals. Preferably, R¹ is in each case independently linear (i.e. unbranched) or branched or cyclic, saturated or unsaturated, aliphatic or aromatic, or else a combination thereof, where this is possible. More preferably, R¹ is in each case independently a saturated aliphatic radical that is linear or branched. It is even more preferable that R¹ is a linear or branched or cycloaliphatic radical having 6 to 13 carbon atoms. Even more preferably, R¹ is a linear aliphatic radical, selected in particular from the group consisting of n-hexyl, n-heptyl, n-octyl, n-nonyl, n-decyl, n-undecyl and n-dodecyl. Suitable compounds of formulas (B) and (C) and (D) and the syntheses thereof are described in EP 1 078 946 A1 and are commercially available for example under the name Tegomer® DA 646.

The radical R¹ is derived from corresponding hydroxy-functional compounds R¹(OH)ₙ, where n is as defined in formulas (B) and (D). Examples of suitable hydroxy-functional compounds R¹(OH)ₙ are given in the examples (see Table 1). Further suitable hydroxy-functional compounds R¹(OH)ₙ may be selected from the group of sugars and sugar alcohols, for example glucose, gulose and sorbitol. It is additionally also possible to use polyglycerols as hydroxy-functional compounds R¹(OH)ₘ.

It is preferable that R² contains no SO units, no PO units, no BO units and no EO units. R² is preferably hydrogen (H).

It is preferable that the number-average molecular weight (Mₙ) of the polyalkylene oxides is from 400 g/mol to 4000 g/mol, preferably from 500 g/mol to 2500 g/mol, especially from 600 g/mol to 1500 g/mol. The number-average molecular weight (Mₙ) is preferably determined by gel-permeation chromatography (GPC).

As well as oxygen atoms, the polyalkylene oxides may contain other heteroatoms such as for example nitrogen atoms. It is however preferable that the polyalkylene oxides do not contain any phosphorus atoms. It is further preferable that the polyalkylene oxides do not contain any sulfur atoms. It is therefore also preferable that the polyalkylene oxides do not contain any other heteroatoms apart from oxygen and optionally nitrogen atoms. The polyalkylene oxides are thus preferably composed only of carbon, hydrogen, oxygen and optionally nitrogen atoms. The polyalkylene oxides thus preferably consist of carbon, hydrogen, oxygen and optionally nitrogen atoms. It is particularly preferable that the polyalkylene oxides do not contain any other heteroatoms apart from oxygen atoms. The polyalkylene oxides are thus particularly preferably composed only of carbon, hydrogen and oxygen atoms. The polyalkylene oxides thus particularly preferably consist of carbon, hydrogen and oxygen atoms.

It is further preferable that the graphene material is a graphene material according to ISO-TS 80004-13, preferably selected from the group consisting of monolayer graphene, bilayer graphene, trilayer graphene, few-layer graphene, multilayer graphene, one-to-ten layer graphene, epitaxial graphene, exfoliated graphene, graphene nanoribbons, graphene nanoplates, graphene nanoplatelets, graphene nanosheets, graphene microsheets, graphene nanoflakes, graphene quantum dots, graphene oxide, graphene oxide nanosheets, multilayer graphene oxide and reduced graphene oxide, and mixtures thereof, particular preference being given to graphene material having one to ten graphene layers.

It is preferable that the graphene material has a carbon content (content by mass of carbon based on the total mass of the graphene material) of at least 80%, preferably at least 90%, especially at least 95%.

The graphene material is preferably a one-layer or multilayer graphene material, i.e. a graphene material that comprises one or more graphene layers. As a multilayer graphene material, preference is given to using a graphene material having two to ten graphene layers.

It is preferable that the graphene material has a thickness of less than 10 nm, preferably less than 5 nm, especially less than 3 nm.

It is preferable that the graphene material has a bulk density of from 0.01 g/cm³ to 0.10 g/cm³, preferably from 0.01 g/cm³ to 0.08 g/cm³, especially from 0.01 g/cm³ to 0.05 g/cm³.

Preferably, the graphene material is present in the form of granules, flakes, powders, films, sheets, platelets, nanoribbons and/or fibres.

Further details on graphene material and on the production, properties and uses thereof can also be found in the technical literature (see Rompp online, https://roempp.thieme.de/lexicon/RD-07-02758; Angew. Chem. Int. Ed. 2014, 53, 7714-7718; Mater. Today 2012, 15 (3), 86-97).

The graphene material can be dispersed in liquid continuous phases with the aid of the polyalkylene oxides mentioned above. It is preferable that the graphene material is dispersed in a liquid continuous phase containing as principal constituent compounds selected from the group consisting of polyethers, especially polyether polyols, polyesters, especially polyester polyols, polycarbonates, especially polycarbonate polyols, polybutadienes, especially polybutadiene polyols, epoxy resins, polysiloxanes, silicone oils, vegetable oils, mineral oils, synthetic organic oils, silyl-modified polymers, silyl-modified reactive diluents, (meth)acrylic acid, (meth)acrylates, cyanoacrylates, dihydrolevoglucosenone (Cyrene®), dimethylformamide (DMF), organic carbonates, acetone, glycols, dimethyl sulfoxide (DMSO), tetrahydrofuran (THF), methyl ethyl ketone (MEK), acetates, N-methyl-2-pyrrolidone (NMP), alcohols and dibasic esters (DBE).

Preferably, the vegetable oil is selected from the group consisting of linseed oil, soybean oil, rapeseed oil, castor oil, epoxidized linseed oil, epoxidized soybean oil, epoxidized rapeseed oil and epoxidized castor oil.

The silyl-modified polymers preferably have triethoxysilyl and/or trimethoxysilyl groups. It is preferable that the polymer backbone is a polysiloxane (silicone), polybutadiene or polyether backbone.

The designation “(meth)acrylic acid” denotes methacrylic acid and/or acrylic acid. The designation “(meth)acrylate” denotes methacrylic esters and/or acrylic esters. (Meth)acrylates are preferably selected from the group consisting of n-butyl methacrylate, isobutyl methacrylate, cyclohexyl methacrylate, 2-hydroxyethyl methacrylate, 2-ethylhexyl methacrylate, methyl methacrylate, ethyl methacrylate, vinyl methacrylate, n-butyl acrylate, isobutyl acrylate, cyclohexyl acrylate, 2-hydroxyethyl acrylate, 2-ethylhexyl acrylate, methyl acrylate, ethyl acrylate and vinyl acrylate.

Organic carbonates are preferably selected from the group consisting of dimethyl carbonate, propylene carbonate, allyl ethyl carbonate, vinylene carbonate, methyl ethyl carbonate, ethylene carbonate, fluoroethylene carbonate, butylene carbonate, diethyl carbonate, methyl propyl carbonate, ethyl propyl carbonate, methyl isopropyl carbonate, dipropyl carbonate, dibutyl carbonate and chloroethylene carbonate.

Glycols are preferably selected from the group consisting of ethylene glycol, diethylene glycol, triethylene glycol, tetraethylene glycol, propylene glycol, dipropylene glycol, tripropylene glycol and tetrapropylene glycol.

Acetates are preferably selected from the group consisting of methyl acetate, ethyl acetate, n-propyl acetate and n-butyl acetate.

Alcohols are preferably selected from the group consisting of ethanol, methanol, propanol, isoamyl alcohol, 1-butanol, isopropanol, phenoxyethanol and 2-(2-phenoxyethoxy) ethanol.

Dibasic esters (DBE) are preferably selected from the group consisting of dimethyl succinate (DBE-4), dimethyl glutarate (DBE-5) and dimethyl adipate (DBE-6). Mixtures are typically used, for example DBE-9, which is a mixture of DBE-4 and DBE-5.

It is further preferable that the continuous phase comprises as principal constituent a plasticizer selected from the group consisting of phthalates, citrates and adipates.

It is further preferable that the continuous phase comprises as principal constituent a baking paint, for example one that is silicone-based.

It is further preferable that the continuous phase comprises as principal constituent an unsaturated polyester resin (UPES) or vinyl ester resin.

It is further preferable that the continuous phase comprises as principal constituent a phenolic resin (UF, MUF) or an amino resin.

The principal constituent of the continuous phase is understood as meaning the predominating constituent of the continuous phase in respect of its proportion by mass. It is preferable that the proportion by mass of the principal constituent is at least 50%, preferably at least 90%, especially 100%, based on the total mass of the continuous phase, the upper limit being 100%.

The present invention further provides a process for dispersing graphene material, characterized in that the polyalkylene oxides used according to the invention are employed as dispersants.

It is preferable that the process includes the following indirectly or directly consecutive process steps, preferably directly consecutive process steps:
a) initially charging a continuous phase;
b) adding a dispersant, corresponding to the use according to the invention;
c) adding and dispersing graphene material.

It is alternatively preferable that the process includes the following indirectly or directly consecutive process steps, preferably directly consecutive process steps:
i) initially charging a dispersant, corresponding to the use according to the invention;
j) adding and dispersing graphene material.

The term “dispersant” is here understood to mean the polyalkylene oxides mentioned above. The dispersant thus consists of one or more of the polyalkylene oxides employable according to the invention.

The dispersion preferably takes place under the effect of shearing. This achieves a high input of energy. This causes the agglomerates to break up and exfoliate, creating fresh, unsaturated surfaces. These points of attack, namely functional groups such as hydroxy, carboxy, aldehyde, keto, epoxy and amino groups, and conjugated systems, are suitable for linking for various dispersants and stabilizers. Such in-situ additization makes dispersion very effective, resulting in the achievement of higher filler levels and more stable dispersions. Higher filler levels then leave more room for manoeuvre in the formulation for the end use such as adhesives and sealants and also thermal interface materials.

In the process according to the invention, in particular in steps c) and j), it is possible to employ various dispersion techniques and apparatuses, such as apparatuses selected from the group consisting of ball mill, dissolver (e.g. Dispermat® dissolver), three-roll mill, Ultra-Turrax, wet-jet mill, Conchier apparatus, high-shear mixer, preferably high-speed mixer and Thermomixer. Dispersion can also be accomplished by sonication. Particularly preferably, dispersion is accomplished using a Dispermat® dissolver or ball mill.

It is preferable that the power/energy is introduced/applied for a period of 0.1 min to 99 h, preferably a period of 0.1 min to 2 h, more preferably a period of 1 min to 15 min.

The process according to the invention has the advantage of being very easy to carry out and thus to produce compositions having a high proportion by mass of graphene material.

The present invention still further provides a composition comprising or consisting of:
(a) a continuous phase,
(b) a dispersant, corresponding to the use according to the invention, and
(c) graphene material.

The dispersant is here too understood to mean the at least one polyalkylene oxide mentioned above. The dispersant thus consists of one or more of the polyalkylene oxides employable according to the invention.

It is preferable that the proportion by mass of component (c) based on the mass of the composition is from 0.1% to 90%, preferably from 5% to 60%, especially from 25% to 40%. The mass of component (c) divided by the mass of the composition is thus from 0.1% to 90%, preferably from 5% to 60%, especially from 25% to 40%.

It is preferable that the proportion by mass of component (b) based on the mass of component (c) is from 0.01% to 200%, preferably from 30% to 150%, especially from 50% to 100%. The mass of component (b) divided by the mass of component (c) is thus from 0.01% to 200%, preferably from 30% to 150%, especially from 50% to 100%.

The present invention still further provides a composition comprising or consisting of:
(i) a dispersant, corresponding to the use according to the invention, and
(j) graphene material.

The dispersant is here too understood to mean the at least one polyalkylene oxide mentioned above. The dispersant thus consists of one or more of the polyalkylene oxides employable according to the invention.

It is preferable that the proportion by mass of component (j) based on the mass of the composition is from 0.1% to 90%, preferably from 5% to 60%, especially from 25% to 40%. The mass of component (j) divided by the mass of the composition is thus from 0.1% to 90%, preferably from 5% to 60%, especially from 25% to 40%.

It is preferable that the proportion by mass of component (i) based on the mass of component (j) is from 0.01% to 200%, preferably from 30% to 150%, especially from 50% to 100%. The mass of component (i) divided by the mass of component (j) is thus from 0.01% to 200%, preferably from 30% to 150%, especially from 50% to 100%.

The composition of the invention may comprise further additives, for example fillers to improve electrical conductivity preferably selected from the group consisting of poly(3,4-ethylenedioxythiophene) (PEDOT), polyaniline, carbon nanotubes, carbon black, carbon fibres, metal particles, metal fibres, silver nanowires, graphite (e.g. expanded graphite) and manganese oxide; fillers to improve thermal conductivity preferably selected from the group consisting of hBN, AlN, Al₂O₃, SiO₂, ZnO, MgO, SIC, nanodiamonds; flame retardants; impact modifiers; colour pigments; UV stabilizers; viscosity modifiers; anticaking agents; defoamers; ionic liquids; wetting agents; and/or antiscratch agents.

The combination of components (a), (b) and (c) affords-even with a high content of filler (c)—a stable dispersion, preferably having low viscosity.

Accordingly, the combination of components (i) and (j) likewise affords—with a high content of filler (j)—a stable dispersion, preferably having low viscosity.

The compositions of the invention, especially in the form of a paste, are highly versatile and can be used for example in the automotive sector, in heat exchangers, in electronics applications, in thermal management, in antistatic protection, in the semiconductor industry, in housings, encapsulations, in 3D printing, injection-moulded components, hose systems, membranes, fuel cells, cable systems, for electromagnetic (EMV) shielding, in thermal management in battery systems, and in adhesives and sealants and also potting compounds.

The compositions of the invention, especially in the form of a paste, are in addition suitable as an additive for the following materials: elastomers, thermosets, thermoplastics, thermoplastic elastomers.

The compositions of the invention, especially in the form of a paste, are particularly suitable as an additive for the following materials/uses:
adhesives and sealants (especially for electrically and/or thermally conductive) incl. epoxy resins, phenolic resins, polyurethanes, silane-modified polymers (silyl-modified polymers, SMP), acrylates, reactive hot melts,
silicones (RTV, HTV, LSR, HCR), acrylates,
polyurethanes, for example thermoplastic polyurethanes,
rubbers, preferably SBR, BR, natural rubber, polybutadienes, functionalized polybutadienes,
thermosets, preferably polyurethanes, polyester resins, phenolic resins, epoxy resins, acrylate resins, silicone resins,
thermal interface materials: gap filler, tapes, greases and phase-change materials, potting, packaging, underfills, casts, coatings, protective coatings,
thermoplastic plastic materials, selected from standard thermoplastics, preferably PE, PP, PS, PVC, alpha-olefins, butadiene derivatives, Vestenamer® (Evonik),
in technical thermoplastics, preferably PET, PMMA, PC, POM, PA, PBT, PEBA, TPU, PU, TPE, in high-performance thermoplastics, preferably PPS. PEEK, PES, PI, PEI, in copolymers,
semifinished products,
in the automotive sector: electric drives, thermal management in battery systems, charging infrastructure in the vehicle and externally, electronics and power electronics, fuel cells, sensors, displays, cockpit, interactive surfaces, EMV shielding (electromagnetic shielding).
electronics and power electronics (connection).
connection and dissipation of heat from microchips, electronic components, displays, indicators,
connection and dissipation of heat from LED headlights/spotlights, LEDs, surface illumination, connection and dissipation of heat from communication systems,
hydrogen technology and gas systems that require antistatics and gas-tightness (seals, fuel cells, tanks, connectors, plugs, tubes/cables),
mineral oils, silicone oils, process oils, vegetable oils, modified vegetable oils, oils for motors, hydraulics and drives, greases, gels, phase-change materials, for electrical and thermal conductivity, and also to reduce sliding friction.

In the uses/materials mentioned above, the compositions preferably result in at least one of the following effects:
(improved) electrical conductivity,
(improved) thermal conductivity,
reduced friction,
improved mechanics,
increased scratch resistance,
colouring/pigment,
absorbance of radiation (UV),
antibacterial/antiviral effect,
improved flame retardancy,
reduced gas permeability.

### EXAMPLES

Adduced hereinafter are examples that serve solely to elucidate the execution of this invention to the person skilled in the art. They do not constitute any restriction at all of the subject-matter claimed.

### Dispersant (Dispersing Additive or “Additive” for Short)

The following polyalkylene oxides corresponding to the stoichiometry shown in Table 1 are prepared as inventive dispersants. The numerical values here indicate the molar ratio of alkylene oxide (SO, PO, BO, EO) to starting alcohol. Additive 4 is thus based on 1 mol of SO, 2 mol of BO, 8 mol of PO and 0 mol of EO, in each case based on 1 mol of hexan-1-ol. The starting alcohol and the corresponding alkylene oxides are synthesized as described in EP 1078946 A1. The radical R¹ of the additives in Table 1 is derived from the respectively employed starting alcohol (e.g. hexan-1-ol leads to R¹=hexyl). The following applies to all additives in Table 1: R²=H.

TABLE 1
Chemical composition of dispersing additives 1 to 18

| Product | Starter (alcohol) | SO | PO | BO | EO |
|---|---|---|---|---|---|
| Additive 1 | Hexan-1-ol | 1 | 1 | 0 | 8 |
| Additive 2 | Hexan-1-ol | 1 | 0 | 1 | 6 |
| Additive 3 | Hexan-1-ol | 3 | 10 | 0 | 0 |
| Additive 4 | Hexan-1-ol | 1 | 8 | 2 | 0 |
| Additive 5 | Octan-1-ol | 1 | 1 | 0 | 8 |
| Additive 6 | Octan-1-ol | 1 | 0 | 2 | 10 |
| Additive 7 | Octan-1-ol | 3 | 11 | 0 | 0 |
| Additive 8 | Octan-1-ol | 2 | 12 | 1 | 0 |
| Additive 9 | Trimethylolpropane | 2 | 2 | 0 | 8 |
| Additive 10 | Trimethylolpropane | 2 | 8 | 0 | 0 |
| Additive 11 | Ethane-1,2-diol | 3 | 0 | 0 | 10 |
| Additive 12 | Ethane-1,2-diol | 3 | 12 | 0 | 0 |
| Additive 13 | Octan-1-ol | 3 | 0 | 0 | 11 |
| Additive 14 | Surfynol ® 104 (Evonik) | 3 | 8 | 0 | 0 |
| | (2,4,7,9-tetramethyl-5- | | | | |
| | decyne-4,7-diol) | | | | |
| Additive 15 | Diethylmonoethanolamine | 2 | 15 | 2 | 0 |
| Additive 16 | Diethylmonoethanolamine | 1.5 | 6 | 0 | 0 |
| Additive 17 | Hexan-1-ol | 0 | 0 | 0 | 6 |
| Additive 18 | Hexan-1-ol | 0 | 2 | 0 | 6 |

Dispersants employable in accordance with the invention are additives 1 to 16. These contain aromatic radicals. Dispersants that are not employable in accordance with the invention are additives 17 and 18 and also Solsperse® 39000 (Lubrizol) and Tegomer® DA 100 N (Evonik). These do not contain any aromatic radicals.

### Fillers

### Graphene:

The graphene material used was a graphene having the following properties: Dv50=20 μm (determined by laser diffraction), surface resistance ≤10 ohm/square (four-point sample on a 25 μm film from the filter membrane), tapped density³=0.251 gom³ (according to ASTM D7481).

### Carbon Black:

A filler that is not employable in accordance with the invention is carbon black, which may be used to improve the electrical conductivity. It has a DBP absorption (DBP=dibutyl phthalate) of 119 ml/100 g, determined according to ASTM D 2414, a bulk density of 300 g/dm³ determined according to ASTM D1513, a sieve residue of less than 250 ppm in a 325 mesh sieve and a CTAB surface area (CTAB=cetyltrimethylammonium bromide) of 135 m²/g determined according to method ASTM D3765.

### Production of Pastes Using a Dispermat® Dissolver

The pastes are in general produced discontinuously (batchwise operation) with the aid of a suitable dispersing unit, a dissolver (Dispermat® CV4-Plus dissolver, VMA-Getzmann). The pastes are produced in a 250 ml stainless steel vessel using a dissolver disc having a diameter of 40 mm. For a 250 ml stainless steel vessel, a batch size of 100 g paste is chosen. The stainless steel vessel is according to the particular experiment charged with a defined amount of the continuous phase (for example polyether polyol, polyester polyol, methyl methacrylate, polybutadienediol etc.). If using a dispersing additive, a defined amount of the additive relative to the amount of filler used (additive on pigment=AoP [%]) is added to the continuous phase. “Pigment” and “filler” are understood as meaning the graphene material or carbon black. The following relationships apply between the mass of the continuous phase m_{cont phase}, the total mass of the composition mₜₒₜₐₗ, the mass of the filler m_{filler}, the mass of the additive m_{additive}, the maximum filler level Filler levelₘₐₓ, and the mass of the additive relative to the mass of the amount of filler AoP (additive on pigment):

$${m}_{cont . phase} [ g ] = {m}_{total} [ g ] - ⌈ {m}_{filler} [ g ] + {m}_{additive} [ g ] ⌉$$

$${m}_{cont . phase} [ g ] = {m}_{total} [ g ] - ⌈ {m}_{filler} [ g ] + {m}_{filler} [ g ] \times ( \frac{AoP [ \% ]}{100} ) ⌉$$

$${m}_{conti . phase} [ g ] = {m}_{total} [ g ] - ⌈ ( {m}_{total} [ g ] \times \frac{Filler {level}_{max} [ \% ]}{100} ) + ( {m}_{total} [ g ] \times \frac{Filler {level}_{max} [ \% ]}{100} ) \times ( \frac{AoP [ \% ]}{100} ) ⌉$$

The vessel containing the continuous phase and the dispersing additive is clamped in the Dispermat® dissolver assembly and the stirrer is turned down so that the dissolver disc is present in the continuous phase but is not touching the bottom of the cup. To prevent the dispersing additive from sinking to the bottom of the stainless steel vessel, the dispersing additive is stirred into the continuous phase for 1 minute at 750 rpm (rpm=revolutions per minute). The filler is added very gradually, a portion at a time. During the addition, the stirrer is set to between 750 rpm and 1000 rpm, depending on dust formation. The portionwise addition takes place over a period of approx. 5 minutes. At the end of the addition, the speed of rotation of the stirrer of the Dispermat® dissolver is turned up to 2000 rpm to 2500 rpm so that ideal dispersion can take place. This state is maintained for a further 5 minutes until the graphene-based paste is fully dispersed.

### Visual Assessment of the Storage Stability of the Paste

A test tube with a diameter of 2.5 cm at the base is filled with 40 g of paste and stored at room temperature for 12 h and 72 h and then examined. A further sample is stored at 50° C. for 72 h and then examined. The examination comprises a visual examination by two persons with the naked eye in respect of syneresis and appearance of the paste. The run-off of the paste on a metal spatula is also examined. The following assessment criteria are used. “unstable” or “stable”:

### Unstable (Stability: “No”):

The paste forms at least 2 mm of clear serum on the surface. The paste appears gritty. The paste does not run off the spatula homogeneously.

### Stable (Stability: “Yes”):

The paste forms less than 2 mm of clear serum. The paste appears homogeneous and creamy. The paste runs off the spatula homogeneously.

### Viscosity (Rheological Investigation of the Pastes)

The viscosities of the pastes are determined using a rheometer (Physica MCR 301/Anton Paar). The investigation uses the D-CP/PP7 measuring shaft without transponder (Anton Paar), which is connected to a 25 mm disposable measuring plate (D-PP25/AL/S07 D: 25 mm disposable measuring plate/Anton Paar). Before starting the measurement, the zero gap (here: 0.5 mm) is set. This gap width is used for the measurement of the pastes hereinbelow. This completes the preparation of the rheometer for the measurement A defined amount of the paste is applied to the rheometer plate and the preset measuring gap of 0.5 mm is adjusted. The excess paste at the edges is then removed (“The sample is trimmed”). Only now is the measurement begun. A linear ramp is run with a shear rate of 0.1 s⁻¹ to 1000 s⁻¹. The following conditions/parameters are employed:

| Data points: | | Specifications: | |
|---|---|---|---|
| Number: | 100 | Variable: | \dot{γ} Shear rate |
| Duration: | Linear ramp | Profile: | Ramp (linear) |
| Start value: | 5 s | Start value: | 0.1 [1/s] |
| End value: | 1 s | End value: | 1000 [1/s] |

For the graphical evaluation, the viscosity is plotted against the shear rate. A comparison is then made for example of the course of the curve of pastes with and without additive. It is common also to compare only the values at a shear rate of 1 s⁻¹ and 10 s⁻¹.

### Hegman Grindometer Test

### Equipment Used:

| Grindometer 25 (PD 1510) | Grindometer 100 (PD 1512) |
|---|---|
| Channel dimensions: 13 × 130 mm | Channel dimensions: 13 × 130 mm |
| Number of channels: 2 | Number of channels: 2 |
| Scales: μm/Hegman number | Scales: μm/Hegman number |
| Range: 0-25/8-6 | Range: 0-100/8-0 |

The Hegman grindometer is used to determine the dispersibility of particles or agglomerates in a liquid continuous phase. It does not determine the actual particle size or particle distribution.

The grindometer is a flat steel block into the surface of which are cut two shallow, wedge-shaped channels. In these channels there is a smooth progression from a maximum depth at one end of the grindometer to the zero point at the other end of the steel block. The wedge depth can be read from the scales engraved at the side. The Hegman scale ranges from 0 to 8, a higher Hegman number (Hegman value) indicating smaller particles. The following assignment of Hegman number and μm applies:
0 Hegman=100 μm
4 Hegman=50 μm
8 Hegman=0 μm

The cleaned and dried grindometer is placed on a level and nonslip surface. The channels of the grindometer are filled at the deepest point with the paste under investigation. The paste must flow slightly over the edge of the groove. The doctor blade is positioned parallel to the short side of the grindometer at the deepest point of the channels and quickly drawn perpendicularly to the shallow end of the grindometer channel. Immediately after smoothing out the sample, the grindometer is examined at a right angle to the long side and at an angle of 20° to 30° to its surface, holding it up to the light so that the surface structure of the paste in the channel becomes visible. The point is determined at which particles in relatively large numbers or scratch marks of particles are visible in the channel for the first time and the associated scale value (Hegman scale) is read off.

Disruption occurring early on in the grooves (high Hegman number) means that the paste contains for example residual agglomerates or that the filler (i.e. graphene material or carbon black) is more poorly dispersed in the continuous phase and thus that greater instability of the paste can also be expected, as can the other abovementioned disadvantages of incompletely dispersed graphene in the end use.

The grindometer test is in the further course assessed as follows:

| OK | Hegman number | small particles, no agglomerates, good |
|---|---|---|
| | (8-7) | dispersion, stable paste |
| NOK | Hegman number | large particles, agglomerate, poor |
| (not OK) | (7-0) | dispersion, unstable paste |

### Production of a Graphene Paste

The production of the graphene pastes according to the examples below takes place as follows:
1. Charging a 250 ml metal cup with the continuous phase.
2. Adding the dispersing additive (100% AoP). Stir in briefly with the spatula so that the additive does not settle on the bottom.
3. Stirring the additive into the continuous phase using the Dispermat® dissolver for approx. 1 minute at 750 rpm with a 40 mm dispersing disc.
4. Gradually adding the filler a portion at a time over a period of approx. 5 minutes at 750-1000 rpm.
5. At the end of addition of the filler, stirring further for 5 minutes at 2000-2500 rpm until the filler is completely dispersed.

### Example 1: Pastes Based on Polyether Polyol

For the production of the paste based on polyether polyol, Desmophen® 1110 BD (Covestro) is used as the continuous phase (see Tables 2 and 3):

TABLE 2
Weights [g]

| | | Experiment | | | | | | | | |
|---|---|---|---|---|---|---|---|---|---|---|
| | | 1 | 2 | 3 | 4 | 5 | 6 | 7 | 8 | 9 |
| Continuous | Desmophen ® | 50.0 | 50.0 | 50.0 | 50.0 | 50.0 | 50.0 | 50.0 | 50.0 | 50.0 |
| phase | 1110 BP | | | | | | | | | |
| Dispersing | Solsperse ® | 25.0 | | | | | | | | |
| additive | 39000 | | | | | | | | | |
| | Additive 1 | | 25.0 | | | | | | | |
| | Additive 2 | | | 25.0 | | | | | | |
| | Additive 3 | | | | 25.0 | | | | | |
| | Additive 4 | | | | | 25.0 | | | | |
| | Additive 10 | | | | | | 25.0 | | | |
| | Additive 12 | | | | | | | 25.0 | | |
| | Additive 14 | | | | | | | | 25.0 | |
| | Additive 17 | | | | | | | | | 25.0 |
| Filler | Graphene | 25.0 | 25.0 | 25.0 | 25.0 | 25.0 | 25.0 | 25.0 | 25.0 | 25.0 |

TABLE 3
Results

| | | | | | | Hegman |
|---|---|---|---|---|---|---|
| | Stability | | | Viscosity | | grindometer |
| | 12 h/ | 72 h/ | 72 h/ | 1/s | 10/s | test |
| Experiment | RT | RT | 50° C. | [Pa*s] | [Pa*s] | [OK/NOK] |
| 1 | Yes | Yes | Yes | 51 | 32 | NOK |
| 2 | Yes | Yes | Yes | 63 | 27 | OK |
| 3 | Yes | Yes | Yes | 61 | 26 | OK |
| 4 | Yes | Yes | Yes | 43 | 23 | OK |
| 5 | Yes | Yes | Yes | 41 | 23 | OK |
| 6 | Yes | Yes | Yes | 40 | 21 | OK |
| 7 | Yes | Yes | Yes | 46 | 22 | OK |
| 8 | Yes | Yes | Yes | 37 | 21 | OK |
| 9 | No | No | n.d.* | n.d.* | n.d.* | NOK |

*n.d. = not determined, as the paste had not been initially stable and thus homogeneous sample collection for a viscosity determination was not possible/not necessary

### Example 2: Pastes Based on Polyester Polyol

For the production of a paste based on polyester polyol, Dynacoll® 7250 (Evonik) is used as the continuous phase (see Tables 4 and 5)

TABLE 4
Weights [g]

| | | Experiment | | | | | | | | | |
|---|---|---|---|---|---|---|---|---|---|---|---|
| | | 10 | 11 | 12 | 13 | 14 | 15 | 16 | 17 | 18 | 19 |
| Continuous | Dynacoll ® | 50.0 | 50.0 | 50.0 | 50.0 | 50.0 | 50.0 | 50.0 | 50.0 | 50.0 | 50.0 |
| phase | 7250 | | | | | | | | | | |
| Dispersing | Solsperse ® | 25.0 | | | | | | | | | |
| additive | 39000 | | | | | | | | | | |
| | Tegomer ® | | 25.0 | | | | | | | | |
| | DA 100 N | | | | | | | | | | |
| | Additive 1 | | | 25.0 | | | | | | | 25.0 |
| | Additive 3 | | | | 25.0 | | | | | | |
| | Additive 4 | | | | | 25.0 | | | | | |
| | Additive 7 | | | | | | 25.0 | | | | |
| | Additive 8 | | | | | | | 25.0 | | | |
| | Additive 14 | | | | | | | | 25.0 | | |
| | Additive 15 | | | | | | | | | 25.0 | |
| Filler | Graphene | 25.0 | 25.0 | 25.0 | 25.0 | 25.0 | 25.0 | 25.0 | 25.0 | 25.0 | |
| | Carbon black | | | | | | | | | | 25.0 |

TABLE 5
Results

| | | | | | | Hegman |
|---|---|---|---|---|---|---|
| | Stability | | | Viscosity | | grindometer |
| | 12 h/ | 72 h/ | 72 h/ | 1/S | 10/s | test |
| Experiment | RT | RT | 50° C. | [Pa*s] | [Pa*s] | [OK/NOK] |
| 10 | Yes | No | No | 594 | 201 | NOK |
| 11 | Yes | Yes | No | 488 | 198 | NOK |
| 12 | Yes | Yes | Yes | 381 | 172 | OK |
| 13 | Yes | Yes | Yes | 253 | 161 | OK |
| 14 | Yes | Yes | Yes | 201 | 127 | OK |
| 15 | Yes | Yes | Yes | 225 | 139 | OK |
| 16 | Yes | Yes | Yes | 219 | 139 | OK |
| 17 | Yes | Yes | Yes | 288 | 156 | OK |
| 18 | Yes | Yes | Yes | 216 | 148 | OK |
| 19 | No | No | No | n.d.* | n.d.* | NOK |

*n.d. = not determined, as the paste had not been initially stable and thus homogeneous sample collection for a viscosity determination was not possible/not necessary.

### Example 3: Paste Based on Polybutadiene Diol

For the production of a paste based on polybutadiene diol, Polyvest® HT (Evonik) is used as the continuous phase (see Tables 6 and 7)

TABLE 6
Weights [g]

| | | Experiment | | | | | | | | | |
|---|---|---|---|---|---|---|---|---|---|---|---|
| | | 20 | 21 | 22 | 23 | 24 | 25 | 26 | 27 | 28 | 29 |
| Continuous | Polyvest ® | 50.0 | 50.0 | 50.0 | 50.0 | 50.0 | 50.0 | 50.0 | 50.0 | 50.0 | 50.0 |
| phase | HT | | | | | | | | | | |
| Dispersing | Solsperse ® | 25.0 | | | | | | | | | |
| additive | 39000 | | | | | | | | | | |
| | Tegomer ® | | 25.0 | | | | | | | | |
| | DA 100 N | | | | | | | | | | |
| | Additive 2 | | | 25.0 | | | | | | | 25.0 |
| | Additive 3 | | | | 25.0 | | | | | | |
| | Additive 4 | | | | | 25.0 | | | | | |
| | Additive 7 | | | | | | 25.0 | | | | |
| | Additive 8 | | | | | | | 25.0 | | | |
| | Additive 14 | | | | | | | | 25.0 | | |
| | Additive 15 | | | | | | | | | 25.0 | |
| Filler | Graphene | 25.0 | 25.0 | 25.0 | 25.0 | 25.0 | 25.0 | 25.0 | 25.0 | 25.0 | |
| | Carbon black | | | | | | | | | | 25.0 |

TABLE 7
Results

| | | | | | | Hegman |
|---|---|---|---|---|---|---|
| | Stability | | | Viscosity | | grindometer |
| | 12 h/ | 72 h/ | 72 h/ | 1/s | 10/s | test |
| Experiment | RT | RT | 50° C. | [Pa*s] | [Pa*s] | [OK/NOK] |
| 20 | Yes | No | No | 512 | 186 | NOK |
| 21 | Yes | Yes | No | 429 | 173 | NOK |
| 22 | Yes | Yes | Yes | 335 | 133 | OK |
| 23 | Yes | Yes | Yes | 201 | 121 | OK |
| 24 | Yes | Yes | Yes | 188 | 113 | OK |
| 25 | Yes | Yes | Yes | 167 | 109 | OK |
| 26 | Yes | Yes | Yes | 271 | 128 | OK |
| 27 | Yes | Yes | Yes | 169 | 107 | OK |
| 28 | Yes | Yes | Yes | 208 | 126 | OK |
| 29 | No | No | n.d.* | n.d.* | n.d.* | NOK |

*n.d. = not determined, as the paste had not been initially stable and thus homogeneous sample collection for a viscosity determination was not possible/not
necessary.

### Example 4: Paste Based on Epoxide

For the production of a paste based on epoxide, Epikote® Resin 828 (Hexion) is used as the continuous phase (see Tables 8 and 9):

TABLE 8
Weights [g]

| | | Experiment | | | | | | | |
|---|---|---|---|---|---|---|---|---|---|
| | | 30 | 31 | 32 | 33 | 34 | 35 | 36 | 37 |
| Continuous | Epikote ® | 50.0 | 50.0 | 50.0 | 50.0 | 50.0 | 50.0 | 50.0 | 50.0 |
| phase | resin 828 | | | | | | | | |
| Dispersing | Solsperse ® | 25.0 | | | | | | | |
| additive | 39000 | | | | | | | | |
| | Additive 1 | | 25.0 | | | | | | |
| | Additive 2 | | | 25.0 | | | | | |
| | Additive 3 | | | | 25.0 | | | | |
| | Additive 4 | | | | | 25.0 | | | |
| | Additive 7 | | | | | | 25.0 | | |
| | Additive 8 | | | | | | | 25.0 | |
| | Additive 13 | | | | | | | | 25.0 |
| Filler | Graphene | 25.0 | 25.0 | 25.0 | 25.0 | 25.0 | 25.0 | 25.0 | 25.0 |

TABLE 9
Results

| | | | | | | Hegman |
|---|---|---|---|---|---|---|
| | Stability | | | Viscosity | | grindometer |
| | 12 h/ | 72 h/ | 72 h/ | 1/S | 10/s | test |
| Experiment | RT | RT | 50° C. | [Pa*s] | [Pa*s] | [OK/NOK] |
| 30* | Yes | Yes | No | 540 | 178 | NOK |
| 31 | Yes | Yes | Yes | 796 | 334 | OK |
| 32 | Yes | Yes | Yes | 427 | 169 | OK |
| 33 | Yes | Yes | Yes | 296 | 147 | OK |
| 34 | Yes | Yes | Yes | 329 | 162 | OK |
| 35 | Yes | Yes | Yes | 384 | 188 | OK |
| 36 | Yes | Yes | Yes | 318 | 165 | OK |
| 37 | Yes | Yes | Yes | 663 | 269 | OK |

*hardened after 1 month of storage and accordingly no longer usable.

### Example 5: Pastes Based on Methyl Methacrylate

For the production of a paste based on methyl methacrylate. Meracryl® MMA (Rohm) is used as the continuous phase (see Tables 10 and 11):

TABLE 10
Weight [g]

| | | Experiment | | | | | | | | |
|---|---|---|---|---|---|---|---|---|---|---|
| | | 39 | 40 | 41 | 42 | 43 | 44 | 45 | 46 | 47 |
| Continuous | Meracryl ® | 30.0 | 30.0 | 30.0 | 30.0 | 30.0 | 30.0 | 30.0 | 30.0 | 30.0 |
| phase | MMA | | | | | | | | | |
| Dispersing | Solsperse ® | 35.0 | | | | | | | | |
| additive | 39000 | | | | | | | | | |
| | Tegomer ® | | 35.0 | | | | | | | |
| | DA100 N | | | | | | | | | |
| | Additive 1 | | | 35.0 | | | | | | |
| | Additive 3 | | | | 35.0 | | | | | |
| | Additive 4 | | | | | 35.0 | | | | |
| | Additive 9 | | | | | | 35.0 | | | |
| | Additive 10 | | | | | | | 35.0 | | |
| | Additive 12 | | | | | | | | 35.0 | |
| | Additive 14 | | | | | | | | | 35.0 |
| Filler | Graphene | 35.0 | 35.0 | 35.0 | 35.0 | 35.0 | 35.0 | 35.0 | 35.0 | 35.0 |

TABLE 11
Results

| | | | | | | Hegman |
|---|---|---|---|---|---|---|
| | Stability | | | Viscosity | | grindometer |
| | 12 h/ | 72 h/ | 72 h/ | 1/s | 10/s | test |
| Experiment | RT | RT | 50° C. | [Pa*s] | [Pa*s] | [OK/NOK] |
| 39* | Yes | Yes | No | n.d. | n.d. | NOK |
| 40 | Yes | Yes | Yes | 431 | 186 | NOK |
| 41 | Yes | Yes | Yes | 326 | 152 | OK |
| 42 | Yes | Yes | Yes | 308 | 147 | OK |
| 43 | Yes | Yes | Yes | 263 | 125 | OK |
| 44 | Yes | Yes | Yes | 217 | 119 | OK |
| 45 | Yes | Yes | Yes | 206 | 104 | OK |
| 46 | Yes | Yes | Yes | 272 | 128 | OK |
| 47 | Yes | Yes | Yes | 299 | 133 | OK |

*hardened after 1 month of storage and accordingly no longer usable.

### Example 6: Pastes Based on Vegetable Oil

For the production of a paste based on vegetable oil, castor oil is used as the continuous phase (see Tables 12 and 13):

TABLE 12
Weight [g]

| | | Experiment | | | | | | | |
|---|---|---|---|---|---|---|---|---|---|
| | | 49 | 50 | 51 | 52 | 53 | 54 | 55 | 56 |
| Continuous | Castor oil | 34.0 | 34.0 | 34.0 | 34.0 | 34.0 | 34.0 | 34.0 | 34.0 |
| phase | | | | | | | | | |
| Dispersing | Solsperse ® | 33.0 | | | | | | | |
| additive | 39000 | | | | | | | | |
| | Additive 5 | | 33.0 | | | | | | |
| | Additive 6 | | | 33.0 | | | | | |
| | Additive 7 | | | | 33.0 | | | | |
| | Additive 8 | | | | | 33.0 | | | |
| | Additive 10 | | | | | | 33.0 | | |
| | Additive 12 | | | | | | | 33.0 | |
| | Additive 13 | | | | | | | | 33.0 |
| Filler | Graphene | 33.0 | 33.0 | 33.0 | 33.0 | 33.0 | 33.0 | 33.0 | 33.0 |

TABLE 13
Results

| | | | | | | Hegman |
|---|---|---|---|---|---|---|
| | Stability | | | Viscosity | | grindometer |
| | 12 h/ | 72 h/ | 72 h/ | 1/s | 10/s | test |
| Experiment | RT | RT | 50° C. | [Pa*s] | [Pa*s] | [OK/NOK] |
| 49 | Yes | Yes | No | 2010 | 469 | OK |
| 50 | Yes | Yes | Yes | 1221 | 257 | OK |
| 51 | Yes | Yes | Yes | 1206 | 249 | OK |
| 52 | Yes | Yes | Yes | 917 | 215 | OK |
| 53 | Yes | Yes | Yes | 878 | 203 | OK |
| 54 | Yes | Yes | Yes | 773 | 188 | OK |
| 55 | Yes | Yes | Yes | 748 | 162 | OK |
| 56 | Yes | Yes | Yes | 1273 | 277 | OK |

### Example 7: Pastes Based on Silyl-Modified Polymers (SMPs)

For the production of a paste based on silyl-modified polymers (SMPs). Tegopac® RDS 1 is used as the continuous phase (see Tables 14 and 15):

TABLE 14
Weight [g]

| | | Experiment | | | | | | | | | | | |
|---|---|---|---|---|---|---|---|---|---|---|---|---|---|
| | | 58 | 59 | 60 | 61 | 62 | 63 | 64 | 65 | 66 | 67 | 68 | 69 |
| Continuous | Tegopac ® | 50.0 | 50.0 | 50.0 | 50.0 | 50.0 | 50.0 | 50.0 | 50.0 | 50.0 | 50.0 | 50.0 | 50.0 |
| phase | RDS 1 | | | | | | | | | | | | |
| Dispersing | Solsperse ® | 25.0 | | | | | | | | | | | |
| additive | 39000 | | | | | | | | | | | | |
| | Additive 3 | | 25.0 | | | | | | | | | | |
| | Additive 4 | | | 25.0 | | | | | | | | 25.0 | |
| | Additive 9 | | | | 25.0 | | | | | | | | |
| | Additive 10 | | | | | 25.0 | | | | | | | |
| | Additive 11 | | | | | | 25.0 | | | | | | |
| | Additive 12 | | | | | | | 25.0 | | | | | |
| | Additive 13 | | | | | | | | 25.0 | | | | |
| | Additive 17 | | | | | | | | | 25.0 | | | |
| | Additive 18 | | | | | | | | | | 25.0 | | 25.0 |
| Filler | Graphene | 25.0 | 25.0 | 25.0 | 25.0 | 25.0 | 25.0 | 25.0 | 25.0 | 25.0 | 25.0 | | |
| | Carbon black | | | | | | | | | | | 25.0 | 25.0 |

TABLE 15
Results

| | | | | | | Hegman |
|---|---|---|---|---|---|---|
| | Stability | | | Viscosity | | grindometer |
| | 12 h/ | 72 h/ | 72 h/ | 1/s | 10/s | test |
| Experiment | RT | RT | 50° C. | [Pa*s] | [Pa*s] | [OK/NOK] |
| 58 | Yes | No | No | 282 | 37 | NOK |
| 59 | Yes | Yes | Yes | 248 | 42 | OK |
| 60 | Yes | Yes | Yes | 216 | 41 | OK |
| 61 | Yes | Yes | Yes | 165 | 31 | OK |
| 62 | Yes | Yes | Yes | 129 | 28 | OK |
| 63 | Yes | Yes | Yes | 137 | 28 | OK |
| 64 | Yes | Yes | Yes | 155 | 31 | OK |
| 65 | Yes | Yes | Yes | 269 | 62 | OK |
| 66 | Yes | No | No | n.d.* | n.d.* | NOK |
| 67 | Yes | No | No | n.d.* | n.d.* | NOK |
| 68 | No | No | No | n.d.* | n.d.* | NOK |
| 69 | No | No | No | n.d.* | n.d.* | NOK |

*n.d. = not determined, as the paste had not been initially stable and thus homogeneous sample collection for a viscosity determination was not possible/not necessary.

Only combinations of the polyalkylene oxides and graphene material employable according to the invention lead (irrespective of the continuous phase) to compositions having high stability, low viscosity and to good results in the Hegman grindometer test.

1. A process of dispersing graphene material, comprising:
adding polyalkylene oxides as a dispersant for a graphene material in a liquid continuous phase, wherein the polyalkylene oxides comprise at least one aromatic radical.

2. The process according to claim 1, wherein the at least one aromatic radical is a phenyl radical.

3. The process according to claim 1, wherein a proportion by mass of all aromatic radicals based on a total mass of the dispersant is from 2% to 40%.

4. The process according to claim 1, wherein the polyalkylene oxides further comprise at least one unit of formula —O—CH₂—CHPh- or of formula —CH₂—CHPh-O—, where Ph denotes a phenyl radical.

5. The process according to claim 1, wherein the polyalkylene oxides are selected from compounds of general formula (B),
R¹[O(SO)ₐ(PO)_{b}(BO)_{c}(EO)_{d}R²]ₙ (B)
in which:
R¹ is in each case independently selected from the group of n-valent C₁-C₂₀ organyl radicals;
R² is in each case independently selected from the group consisting of C₁-C₈ acyl radicals, C₁-C₈ alkyl radicals and hydrogen,
SO=styrene oxide,
PO=propylene oxide,
BO=butylene oxide,
EO=ethylene oxide,
n=1 to 6,
a=1 to 10,
b=0 to 50,
c=0 to 10,
d=0 to 50.

6. The process according to claim 1, wherein the polyalkylene oxides do not contain any other heteroatoms apart from oxygen and optionally nitrogen atoms.

7. The process according to claim 1, wherein the graphene material is a graphene material according to ISO-TS 80004-13.

8. The process according to claim 1, wherein the graphene material is dispersed in a liquid continuous phase containing as principal constituent compounds selected from the group consisting of polyethers, polyesters, polycarbonates, polybutadienes, epoxy resins, polysiloxanes, vegetable oils, mineral oils, synthetic organic oils, silyl-modified polymers, silyl-modified reactive diluents, (meth)acrylates, cyanoacrylates, dihydrolevoglucosenone (Cyrene®), dimethylformamide (DMF), organic carbonates, acetone, glycols, dimethyl sulfoxide (DMSO), tetrahydrofuran (THF), acetates, N-methyl-2-pyrrolidone (NMP), alcohols and dibasic esters (DBE).

9. (canceled)

10. The process according to claim 1, including the following indirectly or directly consecutive process steps:
a) initially charging a continuous phase;
b) adding a dispersant;
c) adding and dispersing graphene material.

11. The process according to claim 1, including the following indirectly or directly consecutive process steps:
i) initially charging a dispersant,
j) adding and dispersing graphene material.

12. A composition, comprising or consisting of:
(a) a continuous phase,
(b) a dispersant, in accordance with the provisions according to claim 1, and
c) graphene material.

13. A composition, comprising or consisting of:
(i) a dispersant, in accordance with the provisions according to claim 1, and
(j) graphene material.

14. The composition according to claim 12, wherein a proportion by mass of component (c) based on a mass of the composition is from 0.1% to 90%.

15. The composition according to claim 12, wherein a proportion by mass of component (b) based on a mass of component (c) is from 0.01% to 200%.

16. The process according to claim 1, wherein a proportion by mass of all aromatic radicals based on a total mass of the dispersant is from 7% to 15%.

17. The process according to claim 1, wherein the polyalkylene oxide is selected from compounds of general formula (B),
R¹[O(SO)ₐ(PO)_{b}(BO)_{c}(EO)_{d}R²]ₙ (B)
in which:
R¹ is in each case independently selected from the group of n-valent C₁-C₂₀ organyl radicals;
R² is in each case independently selected from the group consisting of C₁-C₈ acyl radicals, C₁-C₈ alkyl radicals and hydrogen,
SO=styrene oxide,
PO=propylene oxide,
BO=butylene oxide,
EO=ethylene oxide,
n=1 to 3,
a=1 to 3,
b=0 to 15,
c=0 to 3,
d=0 to 15.

18. The process according to claim 1, wherein the graphene material is at least one graphene material according to ISO-TS 80004-13 selected from the group consisting of monolayer graphene, bilayer graphene, trilayer graphene, few-layer graphene, multilayer graphene, one-to-ten layer graphene, epitaxial graphene, exfoliated graphene, graphene nanoribbons, graphene nanoplates, graphene nanoplatelets, graphene nanosheets, graphene microsheets, graphene nanoflakes, graphene quantum dots, graphene oxide, graphene oxide nanosheets, multilayer graphene oxide and reduced graphene oxide, and mixtures thereof.

19. The process according to claim 1, wherein the graphene material is dispersed in a liquid continuous phase containing as principal constituent compounds selected from the group consisting of polyether polyols, polyester polyols, polycarbonate polyols, and polybutadiene polyols.

20. The composition according to claim 13, wherein a proportion by mass of component (j) based on a mass of the composition is from 0.1% to 90%.

21. The composition according to claim 13, wherein a proportion by mass of component (i) based on a mass of component (j) is from 0.01% to 200%.
